(19) United States
(12) Patent Application Publication
(10) Pub. No.: US 2005/0011261 A1
(43) Pub. Date: Jan. 20, 2005

(54) Container and method for measuring and mixing micro and macro amounts

(76) Inventor: Mark Damon Lyon, Eagan, MN (US)

Correspondence Address: Mark Lyon, 3962 Denmark Avenue, Eagan, MN, 55123, US

(21) Appl. No.: 10/617,961

(22) Filed: Jul. 14, 2003

(51) Int. Cl. G01F 19/00; B65D 1/24

(52) U.S. Cl. 73/427; 220/507

(57) ABSTRACT

A container or receptacle capable of measuring a small, “micro” amount, for example, 2 ounces of fertilizer, and then also capable of measuring a larger, “macro” amount, for example, 1 gallon of water, without the need for a secondary measuring device such as a measuring cup. This is accomplished through the use of a supplemental measurement depression formed in the bottom of the receptacle. The supplemental measurement depression is used for measuring the micro amount and the more familiar measurement graduations on the sidewall of the container are used for measuring the macro amount. Four embodiments are presented detailing various configurations of the invention.

### BACKGROUND-FIELD OF INVENTION

This invention (hereinafter referred to as “the present invention”) pertains to containers, for example a bucket, designed to provide a means for easily measuring and mixing a small amount of one material, for example one ounce of fertilizer (the small amount of material hereinafter referred to as the “concentrate”), and then in the same container, adding a much larger amount of another material, for example one gallon of water (the larger amount of material hereinafter referred to as the “dilutent”). The user will, first, fill the present invention with a concentrate, pouring the concentrate into a supplemental measurement depression formed in the bottom of the container until the proper measurement is reached (this small measurement hereinafter referred to as a “micro” measurement). Then, the user will simply add the dilutent on top of the concentrate, filing the container until the solution (the combination of the dilutent and the concentrate hereinafter referred to as the “solution”) reaches one of the large measurement graduations on the sidewall of the container (this large measurement hereinafter referred to as a “macro” measurement). With this invention, the user has a convenient way to measure and mix the two materials together without a secondary measuring device (such as a tablespoon, a measuring cup or a bottle cap). This is accomplished through novel alterations to the bottom and/or sides of the container or through novel alterations in the orientation and placement of the measurement graduations and the means of reading the measurements. In addition, this invention takes a common sense approach for such a measurement in that it is not necessary to be exactly accurate. To better explain, and using the above example, if you have added one ounce of fertilizer into a container, and then add water until it exactly reaches the one gallon graduation, there is not actually one gallon of water that has been added, but rather, one gallon minus one ounce. The error is less than 1%, which is not of any significance for such common, everyday dilutions. Performing this task with a typical bucket is very difficult given the manner in which the measurement graduations appear on the sidewall. To measure one ounce of concentrate in a bucket, the measurement graduations would have to be very closely spaced, very near the bottom and the bucket would have to be extremely level. It would be very difficult to make this measurement. The present invention alleviates these difficulties through four embodiments to be described herein.

Although the preferred use of the present invention involves buckets, it is very likely that the same concept can be applied to bottles, jars, measuring cups, gas cans, mop buckets, feed pails, water troughs, or any container where one may want to mix two or more materials together in a proportionate and convenient manner.

Prior art includes containers with communicating chambers of various sizes all of which have graduation markings with precision relative to the chamber's size. Prior art also includes containers with a single chamber and graduation markings with novel orientations, but only of a single precision relative to the chamber's size. Still other prior art accomplishes the task of measuring amounts with different precisions through the use of a secondary device, like the cap of a bottle, for example, to measure micro amounts and the bottle itself to measure the macro amounts.

The following pertains to the present invention, embodiment 1, wherein, a container has a plurality of supplemental measurement depressions formed into the bottom wall to measure micro amounts of concentrate, and then graduations on the sidewall to measure the macro amounts of the dilutent. In Barnett's Liquid Proportioning Container (U.S. Pat. No. 4,292,846), one must first lay the container on its side, fill a separate chamber with a concentrate to a micro measurement graduation, then place the container upright allowing the concentrate to pour into the main chamber. Then the main chamber is filled with the dilutent to bring the mixture to the proper proportions. Similar methods and design are involved with Fairchild's Mixture Measurer (U.S. Pat. No. 2,030,975), Johnson's Proportioning and Mixing Graduate (U.S. Pat. No. 3,948,105) and Merhar's Graduated Proportioning and Mixing Container (U.S. Pat. No. 5,447,245). With the present invention, embodiment (1), one would instead, fill the first supplemental measurement depression in the bottom of the container with the concentrate allowing it to overflow (communicate) into the next segment if needed, until the proper micro amount is reached. Then, without having to reposition the container, the dilutent is added on top of the concentrate and allowed to fill the remainder of the container up to the dilutent's desired macro measurement graduation.

The following pertains to the present invention, embodiment 2, wherein a container has at least a single supplemental measurement depression positioned and formed in the bottom of the container such that micro measurement graduations may be placed on a wall of the depression. The concentrate is measured within the supplemental measurement depressions itself The container is then filled with the dilutent as above. This is in contrast with the previously cited prior art in that the prior art requires the concentrate to be transferred to a separate chamber in order to mix it with the dilutent. With the present invention, embodiment 2, the dilutent is instead, poured on top of the concentrate just like in embodiment 1. Additionally, Schneider's Medicine Glass (U.S. Pat. No. 1,839,268) requires that the segments (depressions of predetermined capacity) be formed in the sidewall. The present invention, embodiment 2, has its segments formed in the bottom. Schneider also claims a receptacle made of a vitreous material (claim 5) whereas the present invention is not.

The following pertains to the present invention embodiment 3, wherein the container is tilted so as to take advantage of the greater scale of accuracy afforded by the sidewall and/or bottom wall graduations. In Hayes' (U.S. Pat. No. 388,677) invention, the graduations are radiating from a common point. In the present invention, embodiment 3, the container has the typical graduations for measuring the macro amounts. The macro graduations are on the sidewall of the container and are defined by the intersection of the sidewall with any given plane, which is perpendicular to the central axis of the container. The graduations for measuring the micro amounts, however, are defined by the intersection of the sidewall and/or bottom wall with any given plane, which is substantially non-perpendicular to the central axis of the container. In no instance do the graduations radiate from a common point. Rather, non-intersecting parallel planes define them.

The following pertains to the present invention embodiment 4, wherein the supplemental measurement depressions used for the micro measurement are formed into an auxiliary piece with said piece being attached to a wall of a separate container. In essence, any container can therefore be converted into a measuring device capable of micro measurements. Prior art appears to have ignored this aspect of the present invention, embodiment 4.

The classification of these and the present invention fall into the categories of Measuring vessels with indicating means (73/427), Fluid handling with plural compartments (141/325), Dispensing of various subclasses (222/×), Special receptacles where two or more materials are commingled (206/219), Agitating with stationary mixing chambers (366/341) and Bottles and jars with compartments or indicating means (215/6 & 365).

### SUMMARY OF THE INVENTION

The present invention is a container where macro measurements can be made using the graduations on the sidewall, but with the added feature that micro measurements can be made as well. This is done by either 1). Using supplemental measurement depressions of various capacities formed into the bottom of the container or by 2). Using a single supplemental measurement depression that has graduations on the depression wall or by 3). Using graduations on the bottom and/or sidewall when the container is reoriented or by 4). Attaching an auxiliary measuring device for the micro measurements to the inside of an existing container. Prior to the present invention, in order to mix one cup of bleach with one gallon of water in a bucket, one would first have to obtain a measuring cup, pour the bleach into the measuring cup, pour the measuring cup into the bucket, fill the bucket with one gallon of water using the graduations on the bucket's sidewall for reference, then lastly, rinse out the measuring cup. Alternatively, with the present invention in its preferred embodiment, one would pour the bleach directly into the segments in the bottom of the bucket until one cup is reached, then lastly, fill the bucket with one gallon of water using the graduations on the sidewall for reference. With the present invention, the steps of having to find, use and rinse out a measuring cup are eliminated.

### DESCRIPTION OF THE SEVERAL VIEWS OF THE DRAWINGS

Four embodiments are shown in the drawings. Embodiment 1 includes FIGS. 1 through 4. Embodiment 2 includes FIGS. 6 through 10. Embodiment 3 includes FIGS. 11 through 15b. Embodiment 4 includes FIGS. 16 through 21.

FIG. 1 is an isometric view of a container with a portion of the sidewall cut away. The cut-away reveals the supplemental measurement depressions used for micro measurements on the bottom wall as well as the graduations used for macro measurements on the sidewall.

FIG. 2a is an illustration of the method used to fill the container from FIG. 1 with a concentrate. This view is shown in cross section to reveal the movement of the fluid used.

FIG. 2b is an illustration of the method used to fill the container from FIG. 2a with a dilutent. This view is shown in cross section to reveal the movement of the fluids used.

FIG. 3 is an orthographic projection including 2 sectional views. The top view is looking down into the container through its opening, Section B-B is the front view and section A-A is the profile view. The front view depicts the corrugated structure of the bottom of the container. The profile view depicts the two dams that border the corrugations.

FIG. 4 shows a detailed view of the lower left corner of FIG. 3, section B-B.

FIG. 6 is a sectional view through the center of a container. The cross section is perpendicular to the supplemental measurement depression walls shown formed into the bottom. Horizontal lines depict graduation markings for the micro measurements of 1 tablespoon, 2 tablespoons, 3 tablespoons, 4 tablespoons, 1 cup, 2 cups, 3 cups and the macro measurements of 1 gallon, 2 gallons and 3 gallons.

FIG. 7 is an alternative configuration of FIG. 6 where the sloping sidewall of the supplemental measurement depression is “stepped” in order to make the micro measurement graduations easier to read.

FIG. 8 is a sectional view through the center of a container. The supplemental measurement depression formed in the bottom would be round if viewed from above. Micro measurement graduations are shown by horizontal lines marked 1 teaspoon, 2 teaspoons and 3 teaspoons.

FIG. 9 is an alternative configuration of FIG. 8 where the supplemental measurement depression formed in the bottom is larger to accommodate slightly “larger” micro measurements. Horizontal lines indicate the measurement graduations of 1 tablespoon, 2 tablespoons and 3 tablespoons.

FIG. 10 is a front and side view of a container with both views being a cross section of each other. The right most view depicts a channel formed in the bottom by two protrusions. Horizontal lines represent the micro measurement graduations of 1 tablespoon, 2 tablespoons and 3 tablespoons. The left most view shows one of the protrusions spanning from one side of the container to the other. Measurement graduations have been removed for visual clarity.

FIG. 11 is a sectional view of a regular round container through the center axis of the container. The container has been tipped at about a 45-degree angle. A single horizontal line with hatch marks at the bottom of the figure represents the ground, which is level. Horizontal lines inside the container represent the micro measurement graduations of 1 tablespoon, 2 tablespoons, 3 tablespoons, 4 tablespoons, 5 tablespoons and 6 tablespoons. Three line segments along the sidewall of the container represent the macro measurement graduations of 1 gallon, 2 gallons and 3 gallons.

FIG. 12 is a partial view of an alternate configuration of FIG. 11 wherein the point where the container makes contact with the ground has been formed flat so that full contact can be made with the ground.

FIG. 13 is an alternate configuration of FIG. 11 where the container has been tipped at an angle close to 90 degrees. The micro measurement graduations are marked 1 teaspoon, 2 teaspoons, 3 teaspoons and 4 teaspoons.

FIG. 14 is yet another alternate configuration of FIG. 11 wherein one side of the top rim of the container has been elongated to act as both a handle and a support. The container has been tipped until the handle/support has made contact with the ground. The horizontal lines represent the micro measurement graduations for 1 tablespoon, 2 tablespoons, 3 tablespoons, 4 tablespoons, 5 tablespoons and 6 tablespoons.

FIG. 15a is a layout view where the round figure represents the bottom of a container. Drawn on this round figure is a label, one portion of which is applied to the bottom of a container, and the other portion of which is applied to the sidewall of the container. Horizontal lines on the upper portion of the label represent micro measurement graduations for 1 tablespoon, 2 tablespoons, 3 tablespoons, 4 tablespoons and 5 tablespoons.

FIG. 15b is a cross sectional view of a container, which has the label from FIG. 15a, installed. The container is tilted at approximately 45-degress and is shown resting on a level surface depicted by a horizontal line with hatch marks.

FIG. 16 is a top and front orthographic view of an auxiliary measuring device.

FIG. 17 is an isometric view of the device of FIG. 16 with the added feature of having micro measurement graduations for 1 tablespoon and 2 tablespoons.

FIG. 18 is a sectional view of a container showing the auxiliary measuring device of FIG. 16 attached to the bottom of said container.

FIG. 19 is a top, front and profile orthographic view of an auxiliary measuring device having five supplemental measurement depressions.

FIG. 20 is an isometric view of an auxiliary measuring device similar to FIG. 19, however it has been modified to include four supplemental measurement depressions instead of five.

FIG. 21 is a sectional view of a bucket with the auxiliary measuring device of FIG. 19 attached to its bottom.

### DETAILED DESCRIPTION OF THE INVENTION

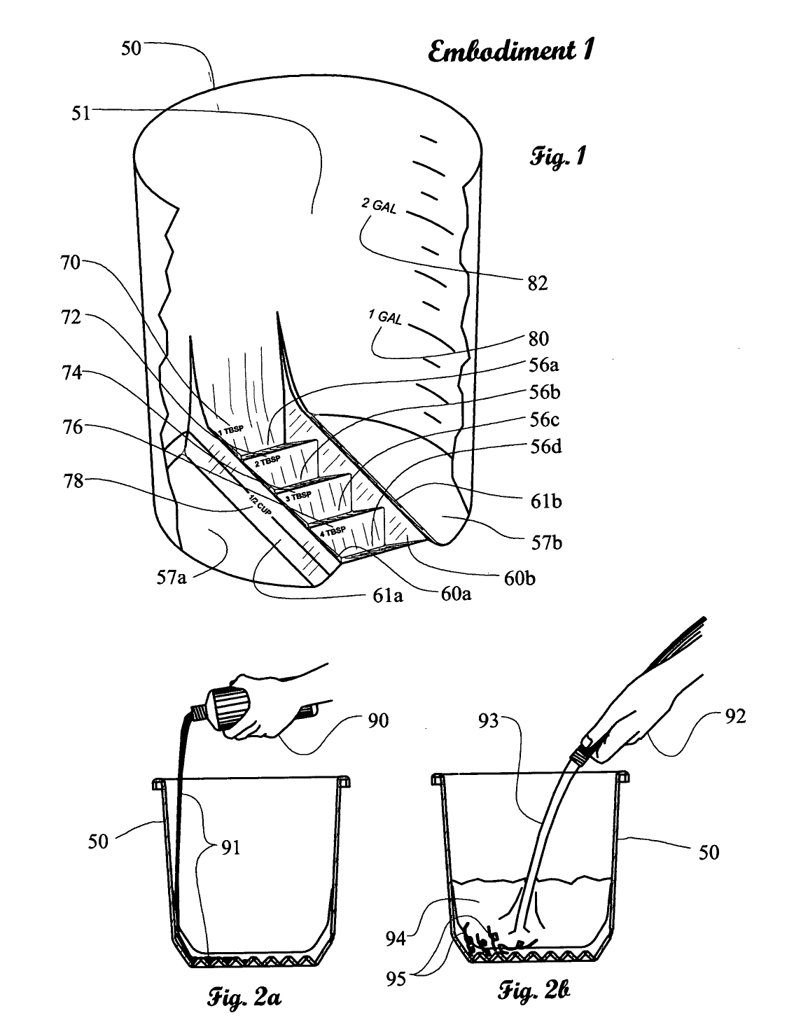

Embodiment 1, FIG. 1, shows a container 50 similar to a household bucket but with novel alterations formed into its bottom. The side of the container closest to the observer has been cut-away and removed to make the inside visible. This type of container is typically injection molded using a thermoplastic material. Therefore, forming depressions into the bottom of the bucket involve a simple modification to the mold and adds no extra cost to the bucket itself A number of supplemental measuring depressions 56a, 56b, 56c and 56d of substantially equal volume are formed into the bottom of the bucket. These depressions are marked with the measurement indicators “1 TBSP” 70, “2 TBSP” 72, “3 TBSP” 74 and “4 TBSP” 76 respectively. In the formation of these depressions yet another set of supplemental measuring depressions are formed, 57a and 57b. Depression 57a abuts a sidewall 61a. On sidewall 61a there is yet another measurement indicator “½ CUP” 78. On the container's sidewall 51 are two more measurement indicators “1 GAL” 80 and “2 GAL” 82. Measurement indicators 70, 72, 74, 76 and 78 are considered micro measurements. Measurement indicators 80 and 82 are considered macro measurements. Of course, any combination of measurements is possible dependant on the shape and size of the depressions that are formed.

Embodiment 1, FIG. 2a shows a container 50 in cross section. A bottle of concentrate is being poured 90 into the container. The stream of concentrate 91 is being shown entering the container and starting to fill the supplemental measurement depressions. FIG. 2b shows the same container 50, however, now a dilutent 93 is being added from a garden hose 92. As the dilutent 93 enters the container, the concentrate begins to nix 95 with the dilutent. The result is a solution 94.

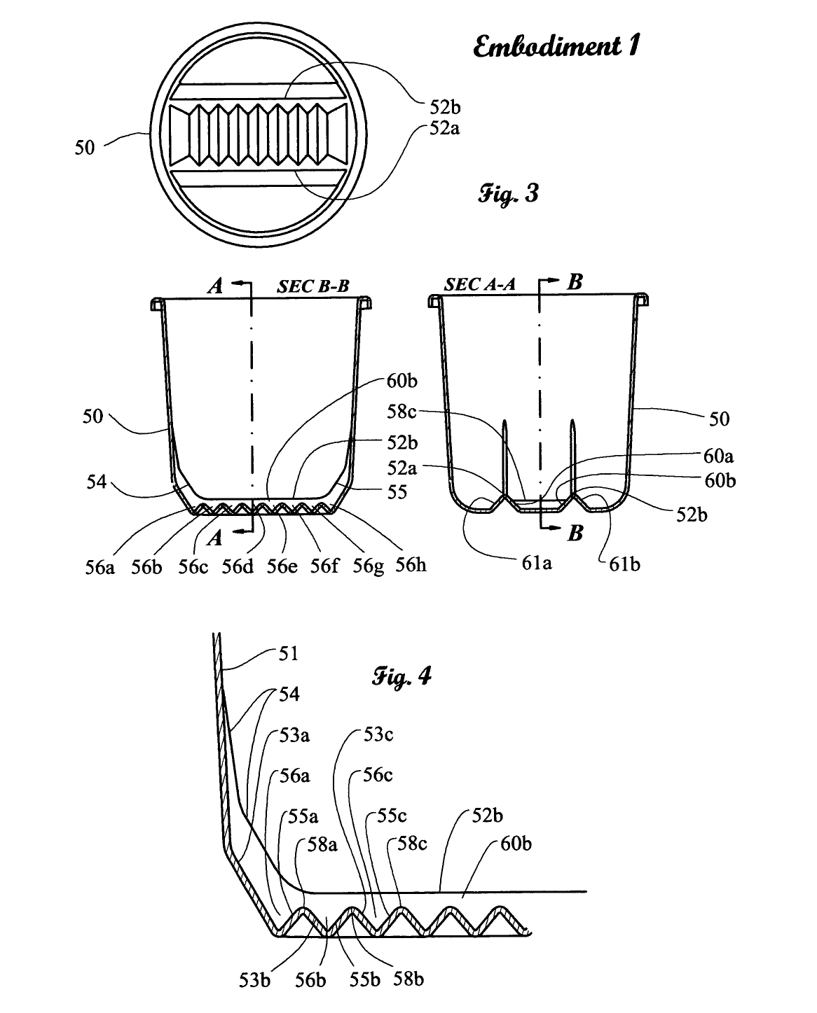

Embodiment 1, FIG. 3, shows a container 50 in SEC B-B, which has a protrusion 54, which descends downward and becomes the trough apex 52b. Descending downward from the trough apex 52b is the interior trough wall 60b. The interior trough wall 60b spans the length of the container and borders the eight supplemental measurement depressions 56a, 56b, 56c, 56d, 56e, 56f, 56g and 56h. This particular container has eight supplemental measurement depressions, however, there can be any reasonable quantity used in a given design. SEC A-A shows the same container rotated 90 degrees and further details the troughs. On either side of the supplemental measurement depressions are the interior trough walls 60a and 60b. The supplemental measurement depression apex 58c is shown spanning from one interior trough wall to the other. This apex 58c is lower than either trough apex 52a or 52b. It is important that the supplemental measurement depression apex be lower than the trough apex in order for a fluid concentrate to be able to spill over from one supplemental measurement depression to the next without spilling over the trough apex. This is what enables the supplemental measurement depressions to communicate with each other. Also shown are the exterior trough walls 61a and 61b.

Embodiment 1, FIG. 4 shows more detail of the supplemental measurement depressions from FIG. 3. As a fluid concentrate is poured into the container, it first hits the inner sidewall 51 of the container and continues down the initial descending sidewall 53a and begins to fill the initial supplemental measurement depression 56a. The supplemental measurement depression 56a is defined by the initial descending sidewall 53a, the initial ascending sidewall 55a and the trough walls 60b and 60a (60a is not shown in FIG. 4). Once the concentrate fills the initial supplemental measurement depression 56a, it begins to spill over the initial measurement apex 58a. It does not spill over the trough apex 52b because 52b is substantially higher than the initial measurement apex 58a. As the fluid concentrate spills over the initial measurement apex 58a, it proceeds down the secondary descending sidewall 53b and begins to fill the secondary supplemental measurement depression 56b. The secondary supplemental measurement depression 56b is defined by the secondary descending sidewall 53b, the secondary ascending sidewall 55b and the trough walls 60b and 60a (60a is not shown in FIG. 4). Once the fluid concentrate has filled the secondary supplemental measurement depression 56b, it will spill over the secondary measurement apex 58b and proceed down the third ascending sidewall 53c and begin to fill the third supplemental measurement depression 56c. The third supplemental measurement depression 56c is defined by the third descending sidewall 53c, the third ascending sidewall 55c and the trough walls 60b and 60a (60a is not shown in FIG. 4). The fluid concentrate will then spill over the third supplemental measurement depression apex 58c once the third supplemental measurement depression 56c is filled. This pattern of events continues either until the user stops pouring the concentrate or until all of the supplemental measurement depressions have been filled. The advantage of this embodiment is that the user can easily see each measurement depression as it fills up and can easily see when the concentrate spills over into the next measurement depression.

Embodiment 2, FIG. 6 is a cross section of a cylindrical container 100 showing two supplemental measurement depressions of a micro scale 121 and 125 that have been formed in the bottom 126. The supplemental measurement depression 121 is formed by the sidewall of the container 120 and wall 122 and the supplemental measurement depression 125 is formed by the sidewall of the container 120 and walls 124 and 126. Walls 122 and 124 are shown on edge. The supplemental measurement depression 121 has four measurement graduations 102, 104, 106 and 108. They have been marked “4 TBSP” 101, “3 TBSP” 103, “2 TBSP” 105 and “1 TBSP” 107 respectively. The supplemental measurement depression 125 has three measurement graduations 110, 112 and 114. They have been marked “3 CUPS” 111, “2 CUPS” 113 and “1 CUP” 115 respectively. The container itself 100 has measurement graduations of a macro scale 131, 132 and 133. They are marked “1 GAL” 116, “2 GAL” 117 and “3 GAL” 118 respectively. This embodiment provides the user with multiple measurement options through the use of non-communicating measurement depressions which have measurement graduations within the measurement depressions themselves.

Embodiment 2, FIG. 7 is a cross section of a cylindrical container 150 showing two supplemental measurement depressions of a micro scale 171 and 180 that have been formed in the bottom 181. The supplemental measurement depression 171 is formed by the sidewall of the container 170 and walls 172, 173, 174, 175, 176, 177 and 178. The supplemental measurement depression 180 is formed by the sidewall of the container 170 and walls 182 and 181. The supplemental measurement depression 171 has four measurement graduations 152, 154, 156 and 158. They have been marked “4 TBSP” 151, “3 TBSP” 153, “2 TBSP” 155 and “1 TBSP” 157 respectively. Walls 173, 175, 177 and 179 are parallel to the bottom 181. The purpose of walls 173, 175, 177 and 179 are to provide a surface whereby the measurement graduations could be engraved (or otherwise marked) in order to provide easy viewing for the user.

Embodiment 2, FIG. 8 is a cross section of a cylindrical container 200 showing one supplemental measurement depression of a micro scale 221 that has been formed in the bottom 226. Wall 227 shares the same plane as the bottom 226. Walls 227 and 224 form the supplemental measurement depression 221. Walls 222 and 224 are conic sections, centered in the container 200. The supplemental measurement depression 221 has three micro measurement graduations 202, 204 and 206. They are marked as “3 TSP” 201, “2 TSP” 203 and “1 TSP” 205 respectively.

Embodiment 2, FIG. 9 is a cross section of a cylindrical container 250 showing one supplemental measurement depression of a micro scale 271 that has been formed in the bottom 276. Wall 277 shares the same plane as the bottom 276. Walls 277 and 274 form the supplemental measurement depression 271. Walls 272 and 274 are conic sections, centered in the container 250. The supplemental measurement depression 271 has three micro measurement graduations 252, 254 and 256. They are marked as “3 TBSP” 251, “2 TBSP” 253 and “1 TBSP” 255 respectively.

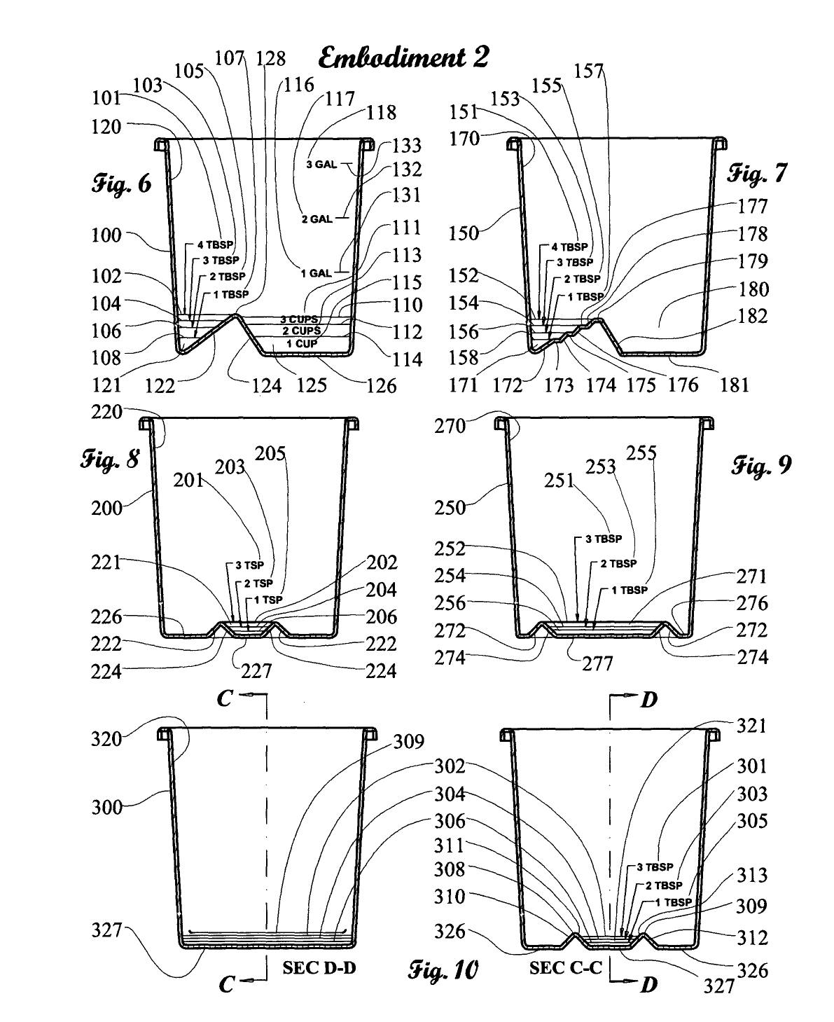

Embodiment 2, FIG. 10 is a cross sectional drawing of a cylindrical container 300, the left most image being a cross section of the front view and the right most image being a cross section of the profile view. A trough shaped supplemental measurement depression of micro scale 321 is formed in the bottom 326 by walls 320, 311, 313 and 327. Wall 327 shares the same plane as the bottom 326. The supplemental measurement depression 321 has three measurement graduations 302, 304 and 306. They are marked as “3 TBSP” 301, “2 TBSP” 303 and “1 TBSP” 305 respectively.

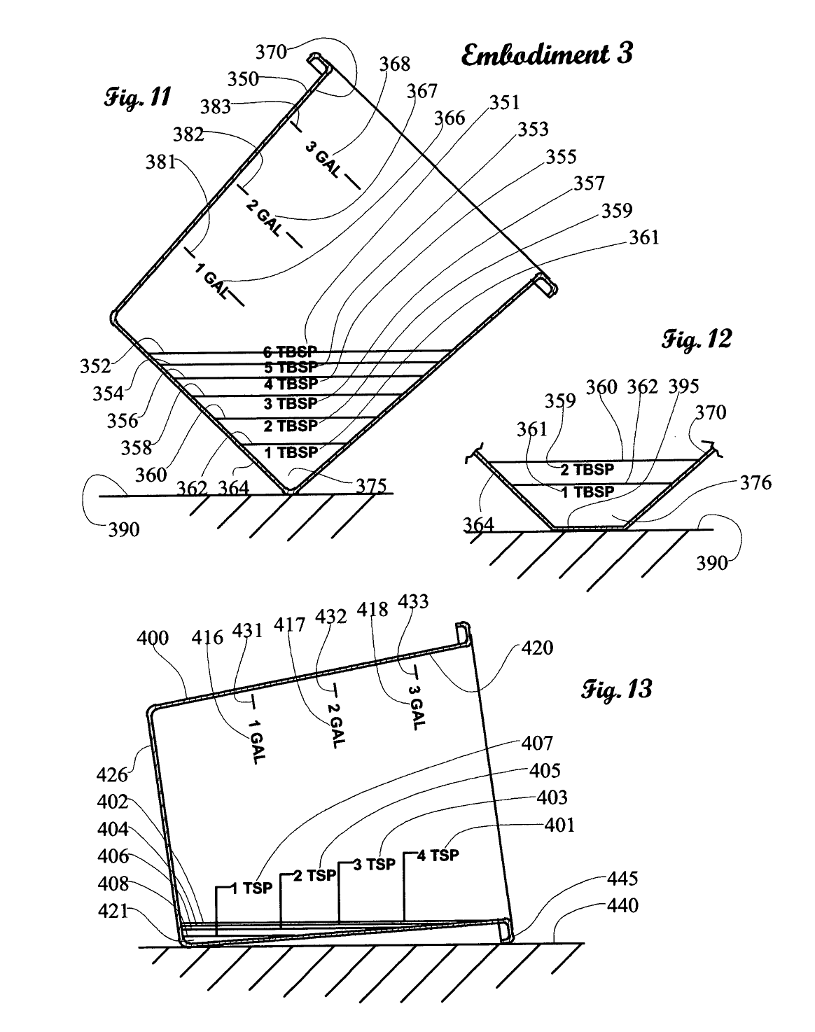

Embodiment 3, FIG. 11 is a cross section of a cylindrical container 350, which has been tilted at a substantially 45-degree angle relative to the ground 390. The act of tilting the container has created a pseudo supplemental measurement depression of a micro scale 375 that is defined by the container sidewall 370 and the bottom 364. Notice that the bottom 364 is flat. The pseudo supplemental measurement depression 375 has six micro measurement graduations 352, 354, 356, 358, 360 and 362. They have been marked “6 TBSP” 351, “5 TBSP” 353, “4 TBSP” 355, “3 TBSP” 357, “2 TBSP” 359 and “1 TBSP” 361 respectively. These measurement graduations 352, 354, 356, 358, 360 and 362 may encompass the entire container at the intersection of a plane parallel to the ground 390 and any other portion of the container 350 provided that plane's height from the ground corresponds to approximately the correct volume that is indicated. The container 350 has measurement graduations of a macro scale 381, 382 and 383. They are marked “1 GAL” 366, “2 GAL” 367 and “3 GAL” 368 respectively. This embodiment provides an alternative way to manufacture a container with micro measurements, by removing the need for “forming” depressions in the bottom.

Embodiment 3, FIG. 12 is a modification to the container of FIG. 11 350, whereby a flat wall 395 has been formed at one point where the sidewall 370 intersects the bottom 364. The flat wall 395 is resting in communication with the ground 390. The flat wall 395 is at a substantially 45-degree angle relative to the bottom 364. The flat wall 395 provides a surface that assists the user in orienting the container at the proper angle for making micro measurements. The act of tilting the container has created a pseudo supplemental measurement depression of a micro scale 376 that consists of the container sidewall 370, the flat wall 395 and the bottom 364. The pseudo supplemental measurement depression 376 has two measurement graduations 360 and 362. They have been marked “2 TBSP” 359 and “1 TBSP” 361 respectively. These measurement graduations 360 and 362 may encompass the entire container at the intersection of a plane parallel to the ground 390 and any other portion of the container 350 provided that plane's height from the ground corresponds to approximately the correct volume that is indicated.

Embodiment 3, FIG. 13 is a cross section of a cylindrical container 400, which has been tilted such that its rim 445 is contacting the ground 440. The act of tilting the container has created a pseudo supplemental measurement depression of micro scale 421 that consists of the container sidewall 420 and the bottom 426. Tilting the container 400 until the rim 445 makes contact with the ground 440 provides an easy way to assists the user in orienting the container at the proper angle for making micro measurements. The pseudo supplemental measurement depression 421 has four measurement graduations 402, 404, 406 and 408. They have been marked “4 TSP” 401, “3 TSP” 403, “2 TSP” 405 and “1 TSP” 407 respectively. These measurement graduations 402, 404, 406 and 408 may encompass the entire container at the intersection of a plane parallel to the ground 440 and any other portion of the container 400 provided that plane's height from the ground corresponds to approximately the correct volume that is indicated. The container 400 has measurement graduations of a macro scale 431, 432 and 433. They are marked “1 GAL” 416, “2 GAL” 417 and “3 GAL” 418 respectively.

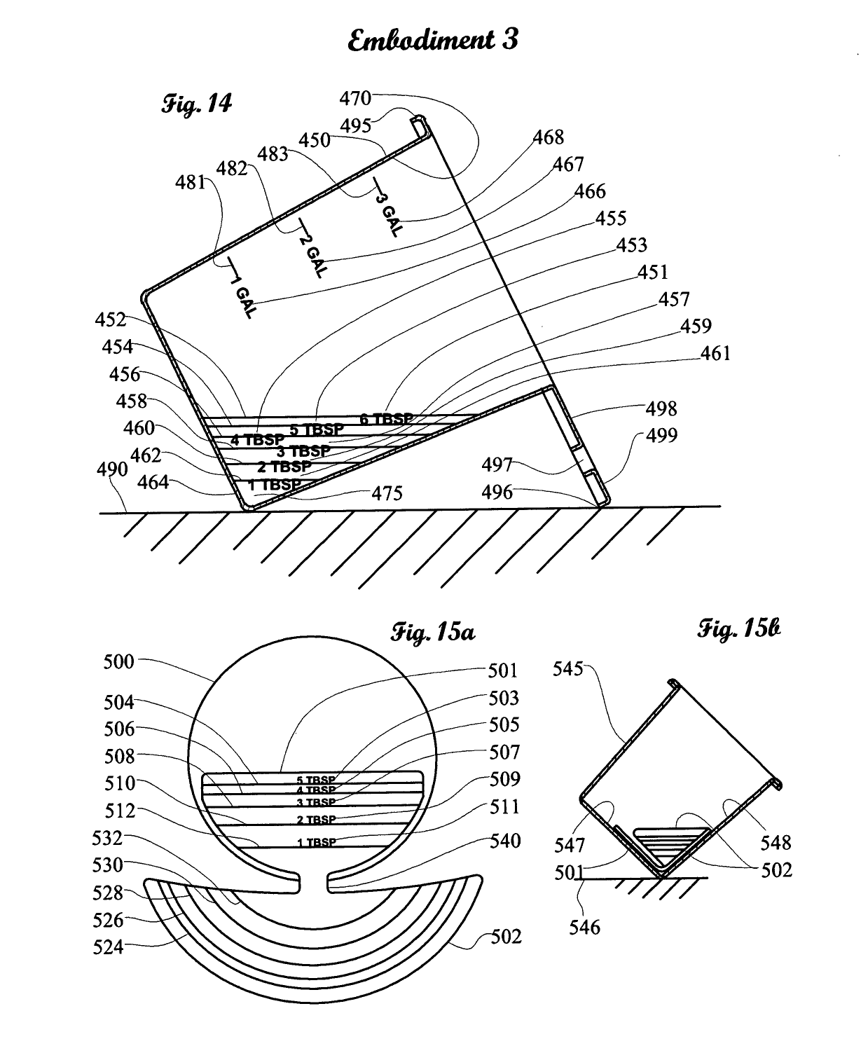

Embodiment 3, FIG. 14 is a cross section of a cylindrical container 450, with a rim 495, which has been extended on one side 498. The extension 498 has a handle opening 497, a handle 499 and an edge 496 that is substantially flat. The container 450 has been tilted such that the edge 496 is contacting the ground 490. The act of tilting the container has created a pseudo supplemental measurement depression of a micro scale 475 that consists of the container sidewall 470 and the bottom 464. Tilting the container 450 until the edge 496 makes contact with the ground 490 provides an easy way to assists the user in orienting the container at the proper angle for making micro measurements. The pseudo supplemental measurement depression 475 has six measurement graduations 452, 454, 456, 458, 460 and 462. They have been marked “6 TBSP” 451, “5 TBSP” 453, “4 TBSP” 455, “3 TBSP” 457, “2 TBSP” 459 and “1 TBSP” 461 respectively. These measurement graduations 452, 454, 456, 458, 460 and 462 may encompass the entire container at the intersection of a plane parallel to the ground 490 and any other portion of the container 450 provided that plane's height from the ground corresponds to approximately the correct volume that is indicated. The container itself 450 has measurement graduations of a macro scale 481, 482 and 483. They are marked “1 GAL” 466, “2 GAL” 467 and “3 GAL” 468 respectively.

Embodiment 3, FIG. 15a, is a plan view of a label 540 made from both water resilient material and adhesive backing or from a static cling. For reference, a circle representing the bottom of a cylindrical container 500 is shown. The upper portion 501 of the label 540 is to be adhered to the bottom of a cylindrical container of the proper diameter. Once the upper portion 501 is attached, the lower portion 502 may be attached to the sidewall of said container (this is further explained in FIG. 15b). Printed on the upper portion 501 are five measurement graduations 504, 506, 508, 510 and 512. They have been marked “5 TBSP” 503, “4 TBSP” 505, “3 TBSP” 507, “2 TBSP” 509 and “1 TBSP” 511 respectively. Printed on the lower portion 502 are five measurement graduations 532, 530, 528, 526 and 524.

Embodiment 3, FIG. 15b is a cross sectional drawing of a cylindrical container 545 which shows the installation of the label from FIG. 15a 540. The upper portion 501 of the label is shown adhered to the bottom 547 of the container 545. The lower portion 502 of the label is shown adhered to the sidewall 548 of the container 545. The container 545 is shown tilted and resting on the ground 546.

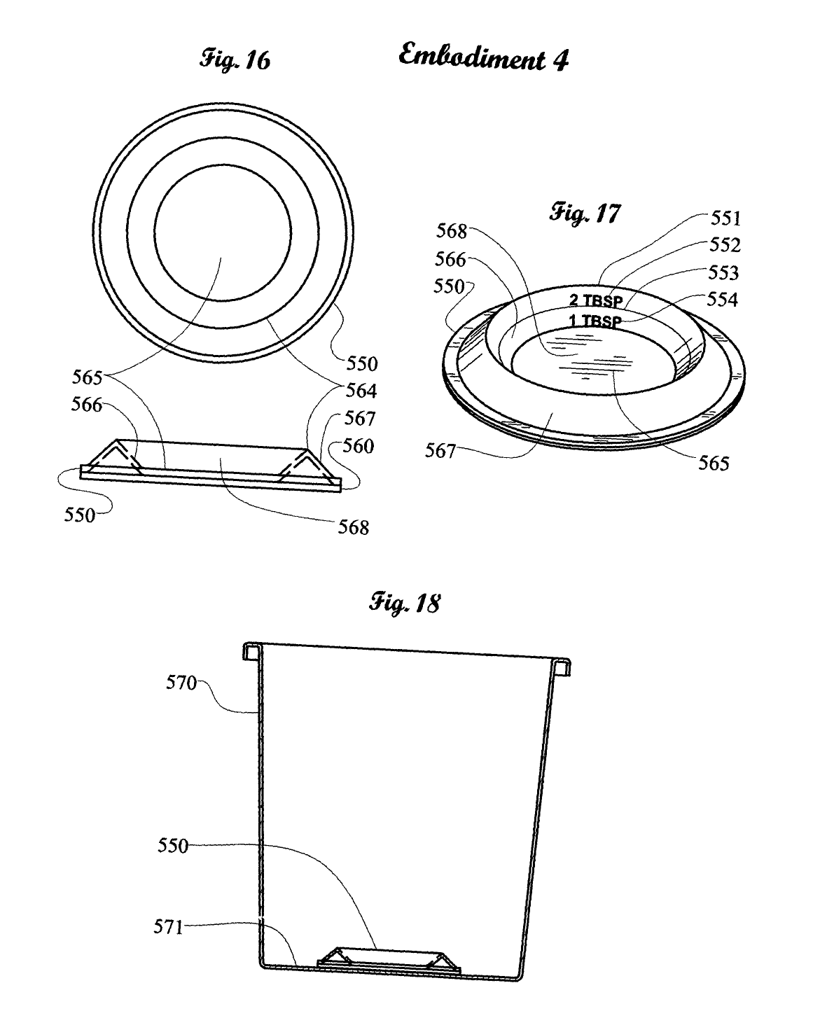

Embodiment 4, FIG. 16 is a top and a front view of an auxiliary supplemental measurement depression 550. The auxiliary supplemental measurement depression 550 has pressure sensitive adhesive 560 applied to the underside of its bottom 565. The pressure sensitive adhesive 560 will be used to secure the auxiliary supplemental measurement depression 550 to the bottom of the proper size container (not shown). A measurement depression 568 is formed in the auxiliary supplemental measurement depression 550 by the inside sidewall 566 and the bottom 565. A concentrate may be poured into the measurement depression 568 up to any given measurement graduation that may be marked on the inside sidewall 566. Once the said concentrate reaches the desired level, a dilutent may be added. In adding a dilutent, the resulting solution will spill over the auxilary supplemental measurement depression apex 564 and continue down the outside sidewall 567.

Embodiment 4, FIG. 17 is an isometric view of the auxiliary supplemental measurement depression 550 of FIG. 16. On the sidewall 566 there are two measurement graduations 551 and 553. They have been marked “2 TBSP” 552 and “1 TBSP” 554 respectively.

Embodiment 4, FIG. 18 is a sectional view of a cylindrical container 570 that has the auxiliary supplemental measurement depression 550 of FIG. 16 attached to the container's bottom 571. The auxiliary supplemental measurement depression 550 is of a size relative to the container 570 such that the amounts of the micro measurements made in the auxiliary supplemental measurement depression 550 will be meaningful to the user.

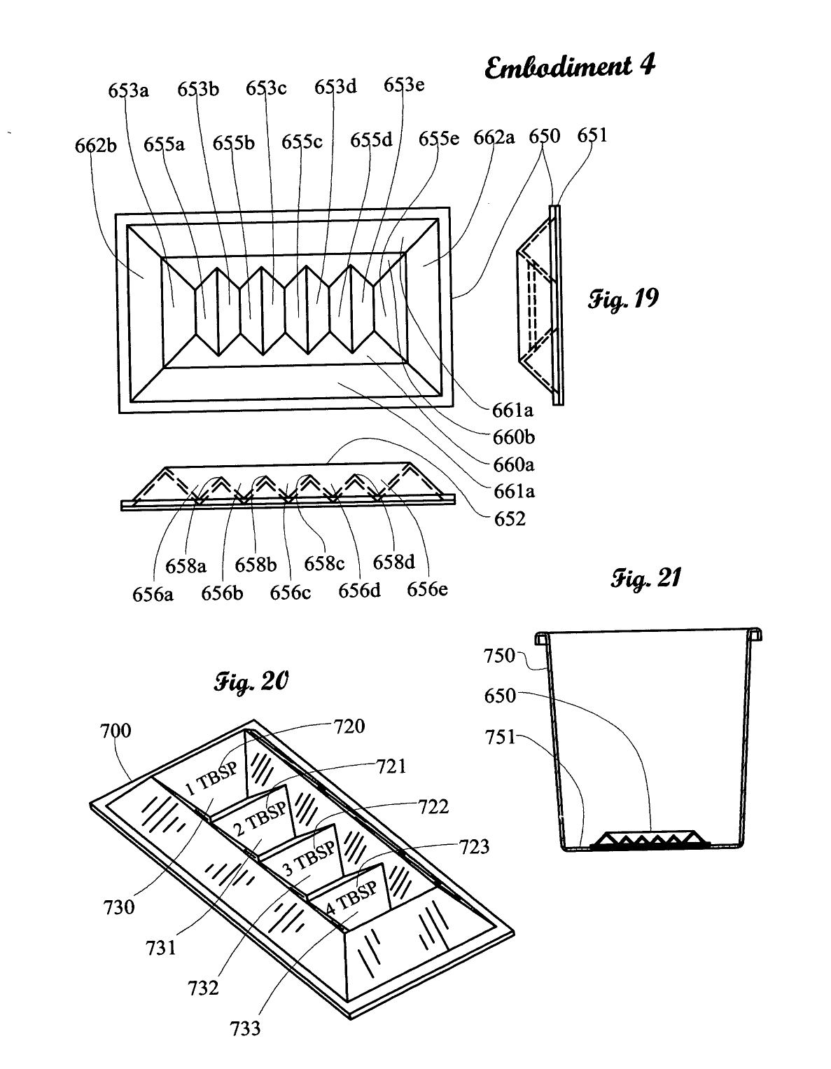

Embodiment 4, FIG. 19 is a top, front and profile view of an auxiliary supplemental measurement depression array 650. The auxiliary supplemental measurement depression array 650 has pressure sensitive adhesive 651 applied to the underside of 650. The pressure sensitive adhesive 651 will be used to secure the auxiliary supplemental measurement depression array 650 to the bottom of the proper size container (not shown). As a fluid concentrate is poured into the auxiliary supplemental measurement depression array 650, it first hits the initial descending sidewall 653a and begins to fill the initial supplemental measurement depression 656a. The initial descending sidewall 653a, the initial ascending sidewall 655a and the trough walls 660a and 660b defines the initial supplemental measurement depression 656a. Once the concentrate fills the initial supplemental measurement depression 656a, it begins to spill over the initial measurement apex 658a. It does not spill over the trough apex 652 because 652 is substantially higher than the initial measurement apex 658a. As the fluid concentrate spills over the initial measurement apex 658a, it proceeds down the secondary descending sidewall 653b and begins to fill the secondary supplemental measurement depression 656b. The secondary supplemental measurement depression 656b is defined by the secondary descending sidewall 653b, the secondary ascending sidewall 655b and the trough walls 660a and 660b. Once the fluid concentrate has filled the secondary supplemental measurement depression 656b, it will spill over the secondary measurement apex 658b and proceed down the third ascending sidewall 653c and begin to fill the third supplemental measurement depression 656c. The third supplemental measurement depression 656c is defined by the third descending sidewall 653c, the third ascending sidewall 655c and the trough walls 660a and 660b. The fluid concentrate will then spill over the third supplemental measurement depression apex 658c once the third supplemental measurement depression 656c is filled. This pattern of events continues either until the user stops pouring the fluid concentrate or all of the five supplemental measurement depressions 656a, 656b, 656c, 656d and 656e have been filled.

Embodiment 4, FIG. 20 is an isometric view of an auxiliary supplemental measurement depression array similar to that shown in FIG. 19, however, there are four supplemental measurement depressions 730, 731, 732 and 733 as opposed to five. The supplemental measurement depressions 730, 731, 732 and 733 are marked with the measurement indices of “1 TBSP” 720, “2 TBSP” 721, “3 TBSP” 722 and “4 TBSP” 723 respectively.

Embodiment 4, FIG. 21 is a sectional view of a cylindrical container 750 that has the auxiliary supplemental measurement depression array 650 of FIG. 19 attached to the container's bottom 751. The auxiliary supplemental measurement depression array 650 is of a size relative to the container 750 such that the amounts of the micro measurements made in the auxiliary supplemental measurement depression array 650 will be meaningful to the user.

1. A receptacle having a main compartment provided with an open top approximately as great in area as the maximum cross sectional area of said compartment and having a supplemental measuring depression of predetermined capacity formed in the bottom of said compartment.

2. The receptacle of claim 1 where said supplemental measuring depression includes at least one measurement graduation.

3. The receptacle of claim 1 where there is a plurality of said supplemental measuring depressions.

4. The receptacle of claim 3 where at least two of the said plurality of said supplemental measuring depressions communicates with each other.

5. A method for measuring or mixing a first material and a second material in order to form a solution in a single container, the volume of the said first material being substantially smaller than the volume of said second material, comprising the steps of:
a. dispensing the said first material until the desired measurement is attained, and
b. dispensing the said second material into said container, and
c. allowing the said first material and said second material to commingle and form a said solution, and
d. continuing the said dispensing of the said second material until the said solution reaches the desired measurement of the said second material,
whereby no separate measuring device is used, and the said desired measurement of the said second material is in actuality the said measurement of the said solution, therefore resulting in approximate proportions.

6. A receptacle having a main compartment provided with an open top approximately as great in area as the maximum cross sectional area of said main compartment and having at least one micro measurement graduation, said micro measurement graduation's position being determined by any given plane that intersects both the side and bottom walls of said receptacle such that the volume within the said given plane and said side and bottom walls equals a predetermined capacity.

7. The receptacle of claim 6 where a means is provided to aid the user in orientating the said receptacle so that the said micro measurement graduation lies within said given plane and so the said given plane is substantially level.

8. The receptacle of claim 7 where said means includes a flat wall formed at the intersection of said bottom wall and said side wall of said receptacle, said flat wall being substantially parallel to said given plane.

9. The receptacle of claim 7 where the said means includes the rim of said receptacle being elongated on at least one side such that:
a. the outer edge of the said elongated portion of said rim and:
b. the point on the said bottom wall which is closest to said outer edge, lies substantially in a plane which is parallel to said given plane.

10. A device intended to be installed in a receptacle, said receptacle having a main compartment provided with an open top approximately as great in area as the maximum cross sectional area of said compartment, said device providing a means to make micro measurements.

11. The device of claim 10 where said device is a label and has at least one micro measurement graduation, said label being applied to at least the bottom of said receptacle, said micro measurement graduation position being defined by the intersection of:
a. any given plane parallel to the ground and
b. at least the bottom wall of said receptacle while said receptacle is tilted.

12. The device of claim 10 where said device is formed as a supplemental measurement depression and has at least one measurement graduation.

13. The device of claim 10 where said device is formed as a plurality of said supplemental measurement depressions.

14. The device of claim 12 where at least two said measuring depressions communicate.
